(19) United States
(12) Patent Application Publication
(10) Pub. No.: US 2006/0197459 A1
(43) Pub. Date: Sep. 7, 2006

(54) Layout configuration of flat display device

(75) Inventor: Tung-Yi Tsai, Taipei (TW)

Correspondence Address: BACON & THOMAS, PLLC, 625 SLATERS LANE, FOURTH FLOOR, ALEXANDRIA, VA, 22314, US

(73) Assignee: JEAN CO., LTD., Taipei (TW)

(21) Appl. No.: 11/067,693

(22) Filed: Mar. 1, 2005

(51) Int. Cl. G09G 3/10

(52) U.S. Cl. 315/169.2

(57) ABSTRACT

A layout configuration of a flat display device includes a display panel, a one layer printed circuit board and a backlight unit. The display panel has a plurality of pixel regions. The single printed circuit board has one side mounted thereon a control circuit, a driving circuit, a power unit and an inverter. The control circuit, the driving circuit, the power unit and the inverter are electrically connected to each other via electrical traces of the printed circuit board. The backlight unit is used for emitting light to the display panel.

### FIELD OF THE INVENTION

The present invention relates to a layout configuration, and more particularly to a layout configuration of a flat display device.

### BACKGROUND OF THE INVENTION

Recently, due to the advantages of thin profile, light weight, low driving voltage and low power consumption, various flat display devices are increasingly developed. The commonly used flat display devices include liquid crystal display (LCD) devices, plasma display panel (PDP) devices, electroluminescent display (ELD) devices, and vacuum fluorescent display (VFD) devices.

Referring to FIG. 1, a schematic circuit block diagram of a LCD device is shown. The LCD device 1 comprises a LCD panel 11, an interface circuit 12, a control circuit 13, a driving circuit 14, a power unit 15 and a backlight unit 16, an inverter 17 and a keypad circuit 18.

The LCD panel 11 comprises a plurality of pixel regions (not shown) arranged in a matrix-type configuration. Each pixel region comprises a capacitor structure and a thin film transistor, and is defined by a crossing of a scan line and a data line. The operation principles of the pixel regions are well known in the art and need not intended to be described redundantly herein.

During operation, the video image data received from the interface circuit 12 is modulated into a control signal Sc by the control circuit 13 connected to the keypad circuit 18. In response to the control signal Sc, the driving circuit 14 output a driving signal Sd to drive the pixel region of the LCD panel 11. Via each scan line, all the thin film transistors of the same row are controlled in either a switching-on or switching-off state. Meanwhile, the data lines transmit analog video signals to the switched-on cells electrically connected thereto.

The power unit 15 comprises an AC/DC converter 151 for converting a commercial AC power 10 into a DC voltage. By using a DC/DC converter 152, this DC voltage is converted into desired DC level for the LCD panel 11, the interface circuit 12, the control circuit 13 and the driving circuit 14.

As known, the light source for most flat panel displays is a cold cathode fluorescent backlight. The backlight unit 16 of this LCD device 1 should run on a high AC voltage provided by the inverter 17. The inverter converts the supplied DC power from the AC/DC converter 151 into AC power and steps its voltage up for start-up. Once the backlight unit 16 is started, the inverter 17 drops the voltage down to its operating level. Meanwhile, the backlight unit 16 provides light to the LCD panel 11.

Conventionally, the LCD panel 11 is disposed on the front side of the backlight unit 16. The interface circuit 12, the control circuit 13, the driving circuit 14, the power unit 15 and the inverter 17 are mounted on three separate printed circuit boards (PCBs). These PCBs are arranged on the rear side of the backlight unit 16. Please refer to FIG. 2, which schematically illustrates the layout configuration of four PCBs. The left printed circuit board PCB1 has mounted thereon the electronic components of the inverter 17. The middle printed circuit board PCB2 has mounted thereon the electronic components of the power unit 15. Whereas, the electronic components of the interface circuit 12, the control circuit 13 and the driving circuit 14 are mounted on the right printed circuit board PCB3. The electronic components of the keypad circuit 18 are mounted on the keypad board PCB4. For clarity, only the circuit block is shown in the drawing.

As shown in FIG. 2, the electronic components mounted on the same printed circuit board are electrically connected to each other via electrical traces. Whereas, every two printed circuit boards are connected to each other via a power cord and corresponding connectors. For example, by plugging the wire L1 into the connectors C3 and C5, the printed circuit board PCB2 is electrically connected to the PCB3 for transmitting the converted DC power from the DC/DC converter 152 to the interface circuit 12. By plugging the wire L2 into the connectors C1 and C6, the printed circuit board PCB1 is electrically connected to the PCB3 for transmitting the converted DC power from the AC/DC converter 151 to the inverter 17. On the other hand, once the wire L3, the power code L4 and the wire L5 are coupled to the connectors C2, C4 and C7, the printed circuit boards PCB1, PCB2 and PCB3 are electrically connected to the backlight unit 16, the AC power supply 10 and the LCD panel 11, respectively. Via the connector C8 and the signal cable L6, the video image data is transmitted to the interface circuit 12. The keypad board PCB4 is electrically connected to the control circuit 13 of the printed circuit board PCB3 via the wire L7.

The layout configuration of FIG. 2 has some drawbacks. For example, these four printed circuit boards PCB1, PCB2, PCB3 and PCB4 occupy much space, which is disadvantage for minimization of the overall LCD device. In addition, many wires and connectors are required to connect the circuits between the printed circuit boards PCB1, PCB2 and PCB3. Conventionally, the wire L2 is relatively longer and flexible. Sometimes it strides across some electronic components of the printed circuit boards PCB2 and PCB3, and thus some interference effects may occur between the power cord and the adjacent electronic components. In order to avoid these adverse effects, it is necessary to have the wire L2 in place. Afterward, too many connectors take much space and are not cost-effective.

### SUMMARY OF THE INVENTION

The present invention provides a layout configuration of a flat display device to reduce complexity and cost for mounting electronic components of the flat display device.

In accordance with a first aspect of the present invention, there is provided a layout configuration of a flat display device. The layout configuration comprises a display panel, a one layer printed circuit board and a backlight unit. The display panel has a plurality of pixel regions. The single printed circuit board has one side or two sides mounted thereon a control circuit, a driving circuit, a power unit and an inverter. The control circuit, the driving circuit, the power unit and the inverter are electrically connected to each other via electrical traces of the printed circuit board. The backlight unit is used for emitting light to the display panel.

In an embodiment, the layout configuration further comprises an interface circuit electrically to the control circuit for receiving a video image data.

In an embodiment, the video image data from the interface circuit is modulated to a control signal by the control circuit.

In an embodiment, the driving circuit is electrically connected to the control circuit to generate a driving signal in response to the control signal.

In an embodiment, the driving signal is transmitted from the driving circuit to the display panel for controlling the pixel regions of the display panel.

In an embodiment, the power unit comprises an AC/DC converter and a DC/DC converter. The AC/DC converter converts an AC power into a DC voltage. The DC/DC converter converts the DC voltage into desired operating DC levels for the display panel, the control circuit and the driving circuit.

In an embodiment, the inverter is electrically connected to the AC/DC converter and the backlight unit for converting the DC voltage into a high AC voltage so as to start the backlight unit.

In an embodiment, the flat display device is a liquid crystal display (LCD) device, a plasma display panel (PDP) device, an electroluminescent display (ELD) device and a vacuum fluorescent display (VFD) device.

In accordance with a second aspect of the present invention, there is provided a layout configuration of a flat display device. The layout configuration comprises a display panel, a backlight unit, an interface circuit, a control circuit, a driving circuit, an AC/DC converter, a DC/DC converter and an inverter. The display panel has a plurality of pixel regions. The backlight unit is used for emitting light to the display panel. The interface circuit receives a video image data. The control circuit is electrically connected to the interface circuit for modulating the video image data from the interface circuit to a control signal. The driving circuit is electrically connected to the control circuit for generating a driving signal in response to the control signal. The AC/DC converter converts an AC power into a DC voltage. The DC/DC converter converts the DC voltage into desired operating DC levels for the display panel, the interface circuit, the control circuit and the driving circuit. The inverter electrically is connected to the AC/DC converter and the backlight unit for converting the DC voltage into a high AC voltage so as to start the backlight unit. Especially, the electronic components of the interface circuit, the control circuit, the driving circuit, the AC/DC converter, the DC/DC converter and the inverter are mounted on one side of a one layer printed circuit board and electrically connected to each other via electrical traces of the printed circuit board.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram of a typical LCD device;

FIG. 2 is a schematic top view illustrates the layout configuration of the LCD device of FIG. 1 according to prior art;

FIG. 3 is a schematic top view illustrates the layout configuration of a LCD device according to a first preferred embodiment of the present invention;

FIG. 4 is a schematic top view illustrates the layout configuration of a LCD device according to a second preferred embodiment of the present invention; and

FIG. 5 is a schematic top view illustrates the layout configuration of a LCD device according to a third preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

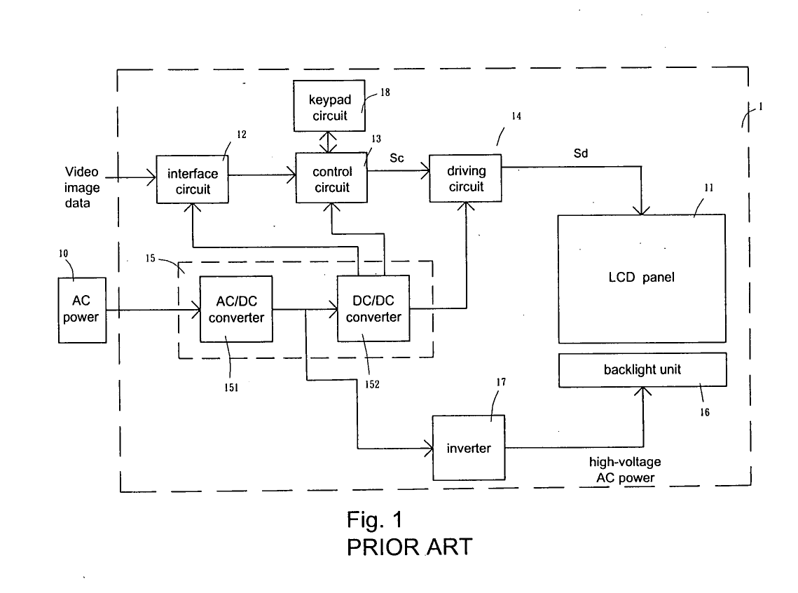

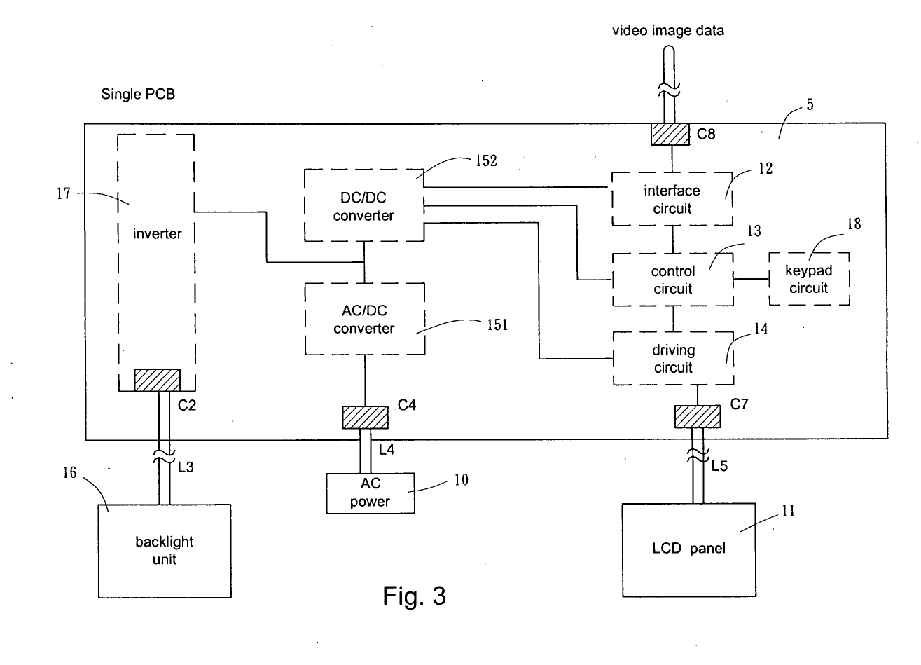

Referring to FIG. 3, a schematic top view of the layout configuration of a LCD device according to a preferred embodiment of the present invention is illustrated. The circuit diagram of the LCD device in this embodiment is substantially the same as that of FIG. 1, and thus the elements corresponding to those in FIG. 1 will be designated by identical numeral references.

In FIG. 3, the electronic components for constituting the interface circuit 12, the control circuit 13, the driving circuit 14, the power unit 15, the inverter 17 and the keypad circuit 18 are mounted on a one-layer printed circuit board 5. The high AC voltage provided by the inverter 17 is transmitted to the backlight unit 16 via the wire L3 and the connector C2. The AC power 10 is supplied to the AC/DC converter 151 via the power cord L4 and the connector C4. The driving signal from the driving circuit 14 is transmitted to the LCD panel 11 via the wire L5 and the connector C7. Likewise, via the connector C8 and the signal cable L6, the video image data is transmitted to the interface circuit 12.

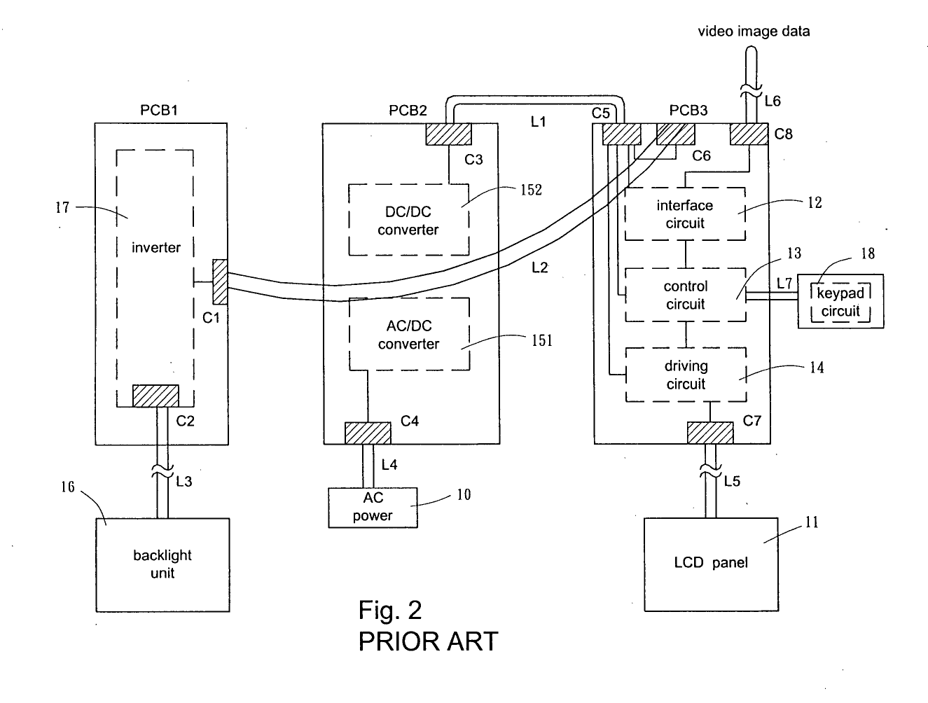

Since the interface circuit 12, the control circuit 13, the driving circuit 14, the power unit 15, the inverter 17 and the keypad circuit 18 are arranged on a single printed circuit board 5 with one-layer substrate, the electronic components mounted thereon will be electrically connected to each other via electrical traces. Since the electronic components are mounted on the single printed circuit board 5 by passing a solder machine once, the fabricating process is very convenient. Furthermore, the wires L1, L2 and L3, the connectors C1, C3, C5 and C6 are exempted from the single printed circuit board 5, when comparing with the layout configuration of FIG. 2. The omission of the wires L1, L2 and L3 avoids the wiring interference caused therefrom and the complex procedure for situating them on a proper place. The omission of the connectors C1, C3, C5 and C6 save the layout space and reduce the overall cost.

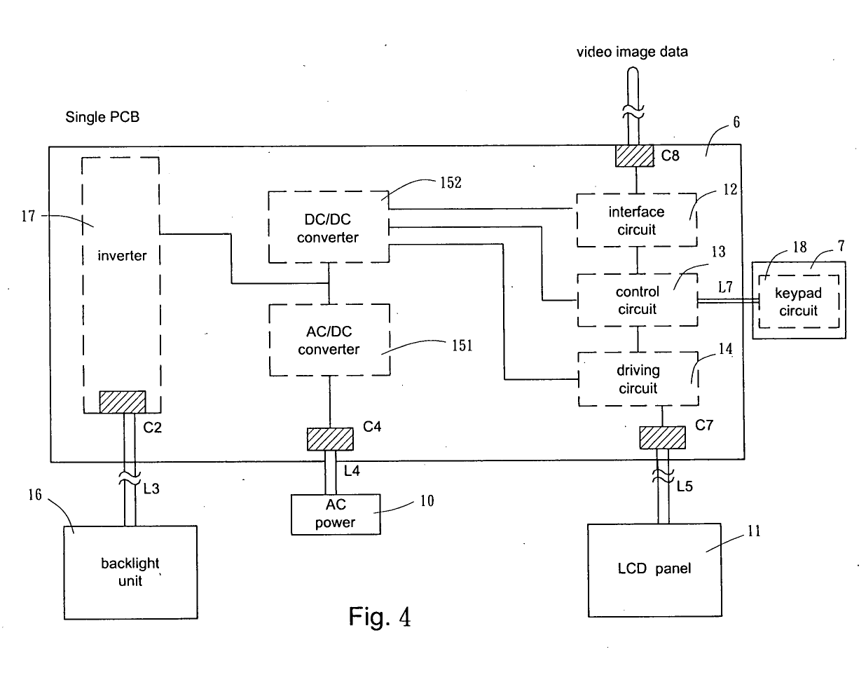

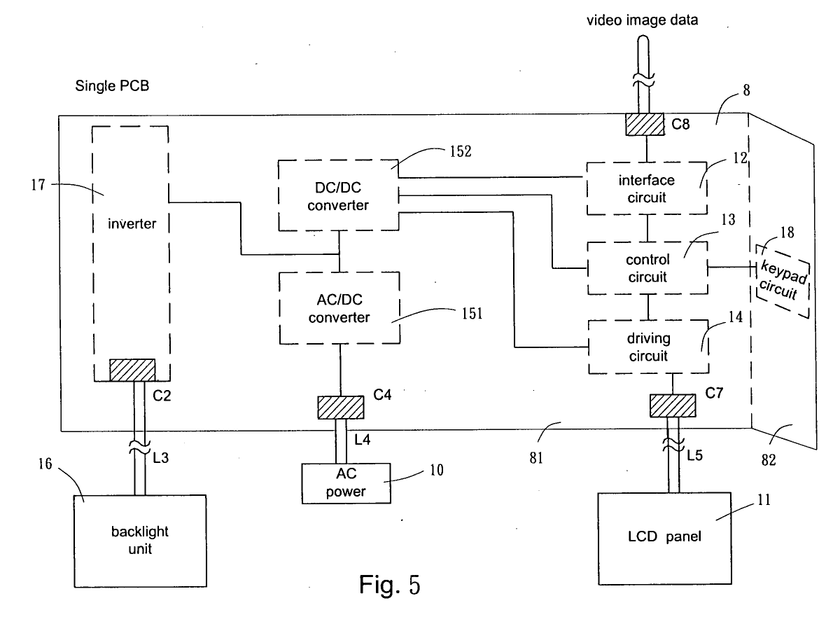

It is noted that, however, those skilled in the art will readily observe that numerous modifications and alterations of the layout configuration may be made while retaining the teachings of the invention. For example, as shown in FIG. 4, the interface circuit 12, the control circuit 13, the driving circuit 14, the power unit 15 and the inverter 17 are mounted on the one-layer printed circuit board 6, while the keypad circuit 18 is mounted on the keypad board 7. Alternatively, as shown in FIG. 5, a one-layer printed circuit board 8 comprises a first portion 81 and a second portion 82 perpendicular to each other. The interface circuit 12, the control circuit 13, the driving circuit 14, the power unit 15 and the inverter 17 are mounted on the first portion 81, and the keypad circuit 18 is mounted on the second portion 82.

The above embodiments are illustrated by referring to a layout configuration of a LCD device. Nevertheless, the present invention can be applied to other flat display devices such as plasma display panel (PDP) devices, electroluminescent display (ELD) devices, and vacuum fluorescent display (VFD) devices.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A layout configuration of a flat display device comprising:
a display panel having a plurality of pixel regions;
a one layer printed circuit board having one side or two sides mounted thereon a control circuit, a driving circuit, a power unit and an inverter, wherein said control circuit, said driving circuit, said power unit and said inverter are electrically connected to each other via electrical traces of said printed circuit board; and
a backlight unit for emitting light to said display panel.

2. The layout configuration according to claim 1 further comprising an interface circuit electrically to said control circuit for receiving a video image data.

3. The layout configuration according to claim 2 wherein said video image data from said interface circuit is modulated to a control signal by said control circuit.

4. The layout configuration according to claim 3 wherein said driving circuit is electrically connected to said control circuit to generate a driving signal in response to said control signal.

5. The layout configuration according to claim 4 wherein said driving signal is transmitted from said driving circuit to said display panel for controlling said pixel regions of said display panel.

6. The layout configuration according to claim 1 wherein said power unit comprises:
an AC/DC converter for converting an AC power into a DC voltage; and
a DC/DC converter for converting said DC voltage into desired operating DC levels for said display panel, said control circuit and said driving circuit.

7. The layout configuration according to claim 6 wherein said inverter is electrically connected to said AC/DC converter and said backlight unit for converting said DC voltage into a high AC voltage so as to start said backlight unit.

8. The layout configuration according to claim 1 further comprising a keypad circuit electrically to said control circuit and mounted on said one layer printed circuit board.

9. The layout configuration according to claim 1 wherein said flat display device is a liquid crystal display (LCD) device, a plasma display panel (PDP) device, an electroluminescent display (ELD) device and a vacuum fluorescent display (VFD) device.

10. A layout configuration of a flat display device comprising:
a display panel having a plurality of pixel regions;
a backlight unit for emitting light to said display panel;
an interface circuit for receiving a video image data;
a control circuit electrically connected to said interface circuit for modulating said video image data from said interface circuit to a control signal;
a driving circuit electrically connected to said control circuit for generating a driving signal in response to said control signal;
an AC/DC converter for converting an AC power into a DC voltage;
a DC/DC converter for converting said DC voltage into desired operating DC levels for said display panel, said interface circuit, said control circuit and said driving circuit; and
an inverter electrically connected to said AC/DC converter and said backlight unit for converting said DC voltage into a high AC voltage so as to start said backlight unit,
wherein the electronic components of said interface circuit, said control circuit, said driving circuit, said AC/DC converter, said DC/DC converter and said inverter are mounted on one side of a one layer printed circuit board and electrically connected to each other via electrical traces of said printed circuit board.

11. The layout configuration according to claim 10 wherein said flat display device is a liquid crystal display (LCD) device, a plasma display panel (PDP) device, an electroluminescent display (ELD) device and a vacuum fluorescent display (VFD) device.

12. A layout configuration of a flat display device comprising:
a display panel having a plurality of pixel regions;
a backlight unit for emitting light to said display panel;
an interface circuit for receiving a video image data;
a control circuit electrically connected to said interface circuit for modulating said video image data from said interface circuit to a control signal;
a keypad circuit electrically connected to said control circuit;
a driving circuit electrically connected to said control circuit for generating a driving signal in response to said control signal;
an AC/DC converter for converting an AC power into a DC voltage;
a DC/DC converter for converting said DC voltage into desired operating DC levels for said display panel, said interface circuit, said control circuit and said driving circuit; and
an inverter electrically connected to said AC/DC converter and said backlight unit for converting said DC voltage into a high AC voltage so as to start said backlight unit,
wherein the electronic components of said interface circuit, said control circuit, said driving circuit, said AC/DC converter, said DC/DC converter, said inverter and said keypad circuit are mounted on a one layer printed circuit board and electrically connected to each other via electrical traces of said printed circuit board.

13. The layout configuration according to claim 12 wherein said one-layer printed circuit board comprises first and second portions perpendicular to each other, said interface circuit, said control circuit, said driving circuit, said power unit and said inverter are mounted on said first portion, and said keypad circuit is mounted on said second portion.

14. The layout configuration according to claim 12 wherein said flat display device is a liquid crystal display (LCD) device, a plasma display panel (PDP) device, an electroluminescent display (ELD) device and a vacuum fluorescent display (VFD) device.
